(19) United States
(12) Patent Application Publication
(10) Pub. No.: US 2003/0071571 A1
(43) Pub. Date: Apr. 17, 2003

(54) Ultraviolet light source driven by capillary discharge plasma and method for surface treatment using the same

(75) Inventors: Dong Woo Yu, Demarest, NJ (US); Steven Kim, Harrington Park, NJ (US); Kurt H. Becker, New York, NY (US)

Correspondence Address: MORGAN LEWIS & BOCKIUS LLP, 1111 PENNSYLVANIA AVENUE NW, WASHINGTON, DC, 20004, US

(73) Assignee: Plasmion Corporation

(21) Appl. No.: 09/976,030

(22) Filed: Oct. 15, 2001

(51) Int. Cl. H01J 17/49

(52) U.S. Cl. 313/582

(57) ABSTRACT

The present invention discloses an ultraviolet light source driven by a capillary discharge plasma and a method for surface treatment using the same. More specifically, an ultraviolet light source driven by a capillary discharge plasma includes an AC power supply as a power source, at least one first electrode connected to the power source, a dielectric body having at least one capillary discharge site therein and enclosing at least a portion of the first electrode, wherein each capillary discharge site is substantially aligned with each first electrode, so that the first electrode is exposed by the capillary site, at least one second electrode electrically coupled to the first electrode, a gas tight chamber enclosing the first and second electrodes and the dielectric body including a working gas, and a window attached to the chamber substantially passing only ultraviolet light from a capillary discharge plasma.

### BACKGROUND OF THE INVENTION

1. Field of the Invention

The present invention relates to a light source, and more particularly, to an ultraviolet light source driven by a capillary discharge plasma and a method for surface treatment using the same. Although the present invention is suitable for a wide scope of applications, it is particularly suitable for surface treatment of large areas with high efficiency at low cost.

2. Discussion of the Related Art

Ultraviolet (UV) light sources have been widely researched because they are a very important tool in the electronics industry for surface treatment and processing. Excimer lasers have been used for deep ultraviolet photolithography. However, the efficiency of such excimer lasers is on the order of one to two percent, which is extremely low. Efficiency in this context is defined as a ratio of light intensity at a desired wavelength to electrical input power required to generate the light intensity. Further, excimer lasers require a high voltage of the multi-kV range to operate the device.

In order to overcome the inherent limitations of the excimer lasers, other light sources have been suggested. Among them, excimer UV light sources driven by either dielectric barrier discharge (DBD) plasmas or microhollow cathode discharge (MHCD) plasmas have been proposed.

The DBD is characterized by the presence of one or more insulating layers in the current path between the metal electrodes in addition to the discharge space. Discharges are initiated at a dielectric surface due to strong electric fields generated by imbedded metal electrodes. The typical operating range for most technical DBD applications lies between about 500 Hz and 500 kHz. For atmospheric pressure discharge operation, the DBD requires alternating driving voltages with amplitudes of typically 10 kV.

Typical parameters for the DBD plasma are as follows: average electron energy of about 0.5 eV with high energy tail; gas temperature in the range of 400 and 1000 K; average plasma density of 10¹¹cm⁻³; and efficiency of about 15 percent.

The MHCD includes a cathode with a single hole or a plurality of holes separated from an anode by a thin sheet of dielectric spacer. The hole or holes may be formed in the surface of the cathode and in the insulating spacer. The hole is not required in the anode. Both DC and AC power may be applied in the MHCD driven light source.

Typically, the MHD plasma has the following parameters: average electron energy of about 1.2 eV with a high energy tail; gas temperature from 500 to 1500 K; average plasma density of 1013 cm⁻³; and efficiency of about 5 percent.

Nonetheless, the above-discussed types of UV light sources can not accomplish high enough efficiencies due to a relatively low average electron energy. Therefore, there has been a demand for a new type of the UV light source that provides better efficiency with relatively low cost than the other types of UV light sources discussed above.

### SUMMARY OF THE INVENTION

Accordingly, the present invention is directed to a ultraviolet light source driven by a capillary discharge plasma and a method for surface treatment using the same that substantially obviates one or more of problems due to limitations and disadvantages of the related art.

Another object of the present invention is to provide to a ultraviolet light source driven by a capillary discharge plasma and a method for surface treatment using the same enabling surface treatment of large areas with high efficiency at low cost.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an ultraviolet light source driven by a capillary discharge plasma includes an AC power supply as a power source, at least one first electrode connected to the power source, a dielectric body having at least one capillary discharge site therein and enclosing at least a portion of the first electrode, wherein each capillary discharge site is substantially aligned with each first electrode, so that the first electrode is exposed by the capillary site, at least one second electrode electrically coupled to the first electrode, a gas tight chamber enclosing the first and second electrodes and the dielectric body including a working gas, and a window attached to the chamber substantially passing only ultraviolet light from a capillary discharge plasma.

In another aspect of the present invention, in a method for surface treatment using an ultraviolet light source driven by a capillary discharge plasma which comprises an AC power supply as a power source, at least one first electrode connected to the power source, a dielectric body having at least one capillary discharge site therein and enclosing at least a portion of the first electrode, wherein each capillary discharge site is substantially aligned with each first electrode, so that the first electrode is exposed by the capillary site, at least one second electrode electrically coupled to the first electrode, a gas tight chamber enclosing the first and second electrodes and the dielectric body, and a window attached to the chamber substantially passing only ultraviolet light from a capillary discharge plasma, the method comprising placing a workpiece in close proximity of the ultraviolet light source, providing the gas tight chamber with a working gas, applying the power source to the first and second electrodes, and emitting ultraviolet light through the window to treat the workpiece.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a schematic cross-sectional view of an ultraviolet light source according to a first embodiment of the present invention;

FIG. 2 is a schematic cross-sectional view of an ultraviolet light source according to a second embodiment of the present invention;

FIG. 3 is a schematic cross-sectional view of an ultraviolet light source according to a third embodiment of the present invention;

FIG. 4 is a schematic cross-sectional view of an ultraviolet light source according to a fourth embodiment of the present invention; and

FIG. 5 is a schematic cross-sectional view of an ultraviolet light source according to a fifth embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

For the purpose of the present invention, ultraviolet light refers to both vacuum ultraviolet light having electromagnetic radiation with a wavelength in the range of about 50 nm to 200 nm and ultraviolet light having electromagnetic radiation with a wavelength in the range of about 200 nm to 400 nm. Further, by selecting a proper filter, a desired range of wavelengths may be obtained in the present invention.

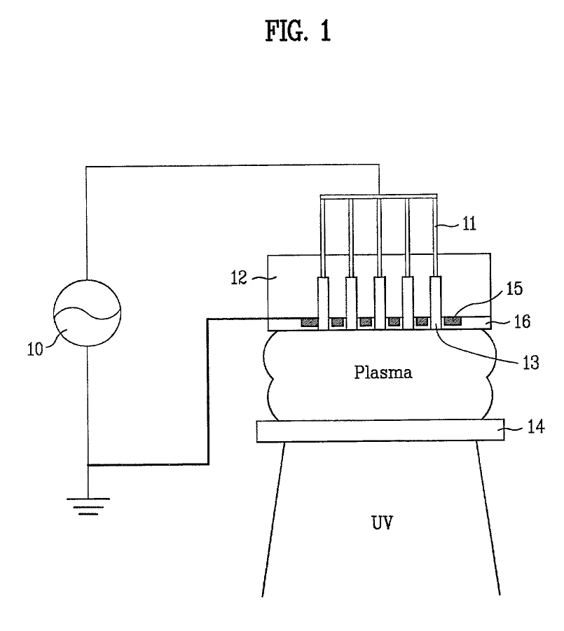

Ultraviolet (UV) light sources driven by a capillary discharge plasma according to various embodiments of the present are illustrated in FIGS. 1 to 5.

A first embodiment of the UV light source is described with reference to FIG. 1. The UV light source includes first and second electrodes 11 and 15, first and second dielectric bodies 12 and 16 attached to each other, a gas tight chamber (not shown) enclosing the above-mentioned elements. The chamber has an ultraviolet light transmissive window 14. The light window 14 may be formed from materials such as MgF2, LiF, quartz, or any other material which is substantially transparent or translucent to light in the UV range. The second dielectric body 12 provides one or more capillary discharge sites 13 therein. Either AC or DC may be applied to the apparatus. If AC is selected for a power source, an AC power supply 10 applies a potential of about 300 to 1000 V and a frequency of 1 to 500 kHz between the first and second electrodes 11 and 15.

The first electrode 11 may be formed as a pin, so that it can be inserted into the first dielectric body in forming the first dielectric body 12. The pin may have any kind of shape in cross-section including a circular shape and a polygonal shape. The dielectric body may be formed by sintering or the like, for example. The first and second dielectric bodies as a whole may have a thickness of about 1 to 30 mm. The second electrode 15 may be completely buried in the second dielectric body 16. One end of the second electrode 15 may be grounded.

Alternatively, the first and second dielectric layer may be formed of a single body. Thus, the first and second electrodes 11 and 15 are buried in the dielectric body when the dielectric body is formed. Thereafter, the capillary discharge sites 13 are formed therein by mechanical drilling or laser drilling. The capillary discharge sites may have a diameter in the range of about 0.1 to 1.0 mm. The cross-sectional shape of the capillary discharge site 13 may have any kind of geometry including a circular or polygonal shape.

When the potential is applied between the first and second electrodes 11 and 15, a plasma is generated by a capillary discharge from the capillary discharge sites 13. The capillary discharge produces excimers in the gas filled and gas tight chamber (not shown). As a working gas, one of Xe, Kr, Ar, Ne, and He may be used in the present invention. Gas mixtures forming compound excimers, such as XeCl, XeF, KrCl, ArCl, ArF, may also be chosen for an excimer production. Further, mixture gases, such as Ne/H₂, Ne/N₂, Ar/O₂ may be also be selected as working gases. The gas pressure may be maintained in the wide ranges, for example, between 100 Torr and 5,000 Torr, thereby facilitating excimer production.

As shown in FIG. 1, a high efficiency plasma is generated by a capillary discharge inside the gas tight chamber. The window 14 is substantially transparent or translucent to light in the UV range, so that UV light is emitted from the apparatus. The present invention is useful for treating a large area of the surface. The UV light may be employed in the following application fields: photo-enhanced chemical vapor deposition, sterilization, ozone production, curing, lithography, ultraviolet microscopy, fluorescent lighting, and liquid crystal display backlighting.

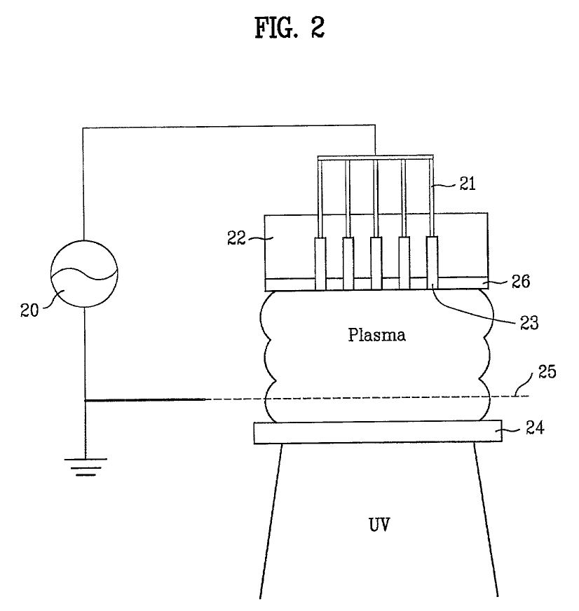

A second embodiment of the present invention is illustrated in FIG. 2. Unlike the first embodiment, a second electrode 25 is not buried in a second dielectric body 26 in the second embodiment. Rather, the second electrode 25 is placed outside an UV transparent window 24. Since other elements of the second embodiment are similar to the first embodiment, detailed descriptions are omitted for simplicity.

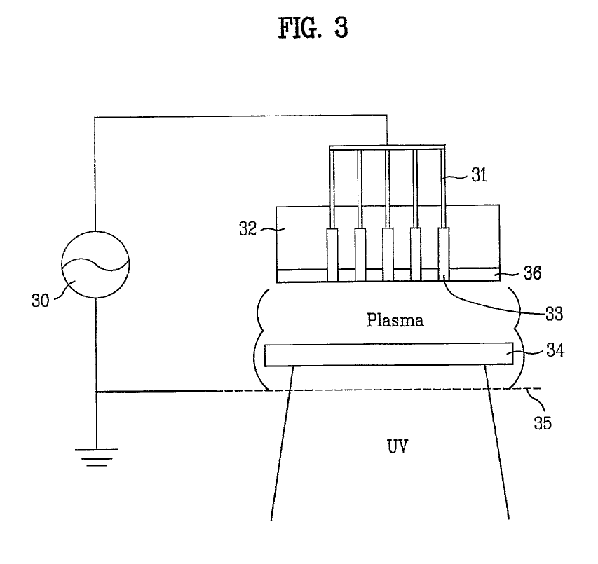

A third embodiment of the present invention is similar to the second embodiment except for the location of the second electrode 35, as shown in FIG. 3. Unlike the second embodiment, a second electrode 35 is located outside a UV transparent window 34 in the third embodiment. Thus, detailed descriptions for other elements are not repeated for simplicity.

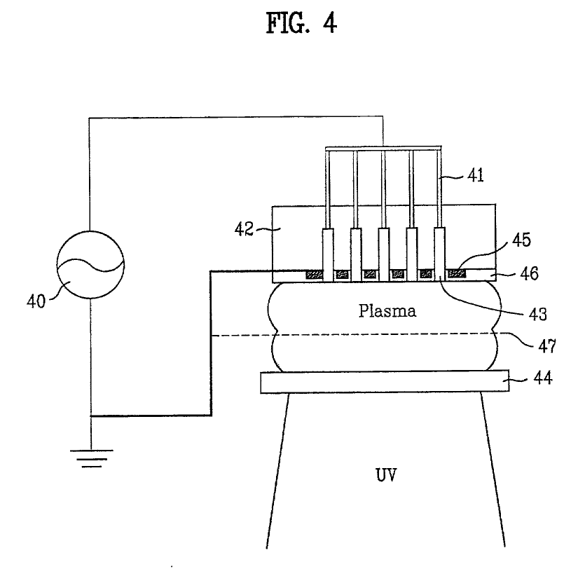

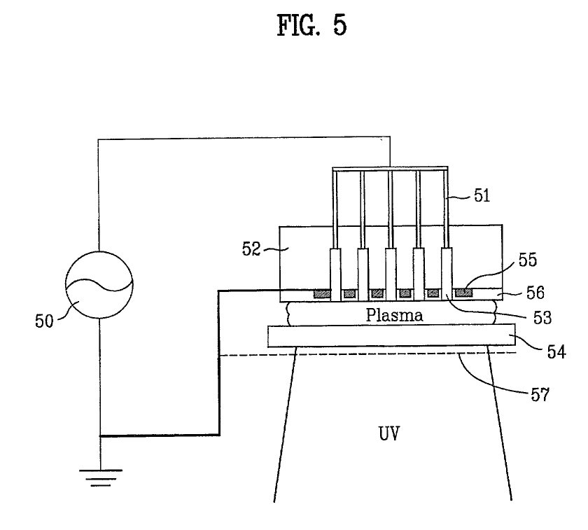

FIGS. 4 and 5 illustrate fourth and fifth embodiments of the present invention. These embodiments are similar to the first embodiment except for that a third electrode 47 and 57 is further added to the apparatus. For simplicity, a detailed description for other elements will be omitted herein. In the fourth embodiment the third electrode 47 is located between a second electrode 46 and the UV transparent window 44. The third electrode 47 acts to direct the produced excimers to the direction of the window 44. Thus, more directed light may be obtained in this embodiment. The third electrode 47 is coupled to the second electrode 46 and grounded. Alternatively, the third electrode 57 in the fifth embodiment may be placed outside a window 54, as shown in FIG. 5.

The UV light source and the method for surface treatment discussed above can treat large surface areas with high efficiency relatively at low cost. For example, typical parameters for the capillary discharge plasma driven UV light source are as follows: average electron energy of about 5 eV with high energy tail; gas temperature from 350 to 450 K; average plasma density of up to 10¹⁴cm⁻³; and efficiency of up to about 15 percent. Thus, the UV light emits much brighter light per surface area.

Further, the present invention provides a UV light source with a relatively simple structure, as described above.

It will be apparent to those skilled in the art that various modifications and variations can be made in the ultraviolet light source driven by a capillary discharge plasma and a method for surface treatment using the same of the present invention without departing from the spirit or scope of the inventions. Thus, it is intended that the present invention covers the modifications and variations of this invention provided they come within the scope of the appended claims and their equivalents.

What is claimed is:

1. An ultraviolet light source driven by a capillary discharge plasma, comprising:
an AC power supply as a power source;
at least one first electrode connected to the power source;
a dielectric body having at least one capillary discharge site therein and enclosing at least a portion of the first electrode, wherein each capillary discharge site is substantially aligned with each first electrode, so that the first electrode is exposed by the capillary site;
at least one second electrode electrically coupled to the first electrode;
a gas tight chamber enclosing the first and second electrodes and the dielectric body including a working gas; and
a window attached to the chamber substantially passing only ultraviolet light from a capillary discharge plasma.

2. The light source according to claim 1, wherein the second electrode is placed in the dielectric layer and at close proximity of each capillary discharge site.

3. The light source according to claim 2, further comprising a third electrode coupled to the second electrode.

4. The light source according to claim 3, wherein the third electrode is located between the second electrode and the window.

5. The light source according to claim 3, wherein the third electrode is located outside the window.

6. The light source according to claim 1, wherein the capillary discharge site has a diameter in the range of 0.1 and 1.0 mm.

7. The light source according to claim 1, wherein the dielectric body has a thickness in the range of 1 and 30 mm.

8. The light source according to claim 1, wherein the dielectric body has first and second parts and the second electrode is located in the second part.

9. The light source according to claim 1, wherein the second electrode is located between the first electrode and the window.

10. The light source according to claim 1, wherein the second electrode is located outside the window.

11. The light source according to claim 1, wherein the window is formed of one of MgF₂, LiF, and quartz.

12. The light source according to claim 1, wherein the working gas includes one of Xe, Kr, Ar, Ne, He, or gas mixtures leading to the formation of compound excimers such as XeCl, XeF, KrCl, ArCl, ArF, orgas mixtures such as Ne/H₂, Ne/N₂, and Ar/O₂.

13. The light source according to claim 1, wherein the power source has a voltage of about 300 to 1000 V and a frequency of about 1 to 500 kHz.

14. The light source according to claim 1, wherein the ultraviolet light is used one of photo-enhanced chemical vapor deposition, sterilization, ozone production, curing, lithography, ultraviolet microscopy, fluorescent lighting, and liquid crystal display backlighting.

15. The light source according to claim 1, wherein the capillary discharge plasma has an average electron energy of up to 5 eV with a high energy tail.

16. The light source according to claim 1, wherein the capillary discharge plasma has a gas temperature in the range of about 350 and 450 K.

17. The light source according to claim 1, wherein the capillary discharge plasma has a plasma density of up to about 10¹⁴cm⁻³.

18. The light source according claim 1, wherein the ultraviolet light has a wavelength in the range of about 50 nm to 400 nm.

19. A method for surface treatment using an ultraviolet light source driven by a capillary discharge plasma which comprises an AC power supply providing a power source, at least one first electrode receiving the power source, a dielectric body having at least one capillary discharge site therein and enclosing at least a portion of the first electrode, wherein each capillary discharge site is substantially aligned with each first electrode, so that the first electrode is exposed by the capillary site, at least one second electrode electrically coupled to the first electrode, a gas tight chamber enclosing the first and second electrodes and the dielectric body, and a window attached to the chamber substantially passing only ultraviolet light from a capillary discharge plasma, the method comprising:
placing a workpiece in a close proximity to the ultraviolet light source;
providing the gas tight chamber with a working gas;
applying the power source to the first and second electrodes; and
emitting an ultraviolet light through the window to treat the workpiece.

20. The method according to claim 19, wherein the working gas includes one of Xe, Kr, Ar, Ne, He,or gas mixtures leading to the formation of compound excimers such as XeCl, XeF, KrCl, ArCl, ArF, or gas mixtures of Ne/H₂, Ne/N₂, and Ar/O₂.

21. The method according to claim 19, wherein the power source has a voltage of about 300 to 1000 V and a frequency of about 1 to 500 kHz.

22. The light source according to claim 19, wherein the capillary discharge plasma has an average electron energy of up to 5 eV with a high energy tail.

23. The light source according to claim 19, wherein the capillary discharge plasma has a gas temperature in the range of about 350 and 450 K.

24. The light source according to claim 19, wherein the capillary discharge plasma has a plasma density of up to about 10¹⁴cm⁻³.
